(19) United States
(12) Patent Application Publication
(10) Pub. No.: US 2008/0047683 A1
(43) Pub. Date: Feb. 28, 2008

(54) Aluminum Heat Exchange Tube and Process for Fabricating Same

(75) Inventor: Kazuyuki Takahashi, Oyama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SHOWA DENKO K.K, Tokyo (JP)

(21) Appl. No.: 11/571,361

(22) PCT Filed: Jun. 28, 2005
(86) PCT No.: PCT/JP05/12285

§ 371 Date: Dec. 28, 2006

Related U.S. Application Data
(60) Provisional application No. 60/584,135, filed on Jul. 1, 2004.

(30) Foreign Application Priority Data
Jun. 28, 2004 (JP) 2004-189577

(51) Int. Cl. B60H 1/00; B21D 53/02; F28F 21/08

(52) U.S. Cl. 165/41; 165/180; 29/890.03

(57) ABSTRACT

An aluminum heat exchange tube 4 is made of an alloy comprising 0.90 to 1.50 mass % of Mn, and the balance Al and inevitable impurities, and has electric conductivity of 30 to 43% IACS. The tube 4 is fabricated from a tube blank made of an alloy comprising 0.90 to 1.50 mass % of Mn, and the balance Al and inevitable impurities, by holding the blank heated at 550 to 600 C in the atmosphere or in an inert gas atmosphere for 10 to 600 minutes and subsequently cooling the blank. The tube is easy and inexpensive to make and satisfactory in resistance to pitting corrosion.

### CROSS REFERENCE TO RELATED APPLICATION

This application is an application filed under 35 U.S.C. §111(a) claiming the benefit pursuant to 35 U.S.C. §119(e) (1) of the filing date of Provisional Application No. 60/584,135 filed Jul. 1, 2004 pursuant to 35 U.S.C. §111(b).

### TECHNICAL FIELD

The present invention relates to heat exchange tubes of aluminum and a process for producing the tube, and more particularly to aluminum heat exchange tubes, for example, for use in heat exchangers such as condensers or evaporators in motor vehicle air conditioners wherein a chlorofluorocarbon refrigerant is used, and gas coolers or evaporators in motor vehicle air conditioners wherein CO₂ or like supercritical refrigerant is used, and to a process for fabricating such tubes.

The term “aluminum” as used herein and in the appended claims includes aluminum alloys in addition to pure aluminum. The metal represented by an atomic symbol of course does not include alloys thereof.

### BACKGROUND ART

For use in motor vehicle air conditioners wherein a chlorofluorocarbon refrigerant is used, condensers are known which comprise a pair of aluminum headers arranged in parallel as spaced apart from each other, flat heat exchange tubes of aluminum arranged in parallel and each having opposite ends joined to the respective headers, corrugated aluminum fins each disposed in an air passage clearance between each adjacent pair of heat exchange tubes and joined to the pair of heat exchange tubes, an aluminum inlet pipe joined to one of the headers, and an aluminum outlet pipe joined to the other header.

The heat exchange tube of the condenser described above is conventionally fabricated, for example, from an alloy containing 0.2 to 1.0 wt. % of Cu, and the balance Al and inevitable impurities (see the publication of JP-B No. 60-22278).

Heat exchanger tubes for use in the condenser of motor vehicle air conditioners have their surfaces heretofore subjected to a chromate treatment and given improved corrosion resistance, but the treatment requires cumbersome work. Since Cr⁶⁺ is a harmful substance, the liquid waste resulting from the treatment necessitates a troublesome treatment for disposal. The heat exchange tube therefore has the problem of requiring cumbersome work for fabrication. Additionally, the use of Cr⁶⁺ is to be prohibited in Europe in the near future.

The heat exchange tube disclosed in the above publication nevertheless fails to exhibit resistance to pitting corrosion unless the tube is subjected to the chromate treatment.

Although it appears feasible to form a Zn layer over the outer peripheral surface of the heat exchange tube by thermal spraying instead of the chromate treatment before brazing to improve the pitting corrosion resistance of the tube, this procedure also has the problem of being cumbersome and costly to practice.

An object of the present invention is to overcome the above problems and to provide an aluminum heat exchange tube which is easy and inexpensive to fabricate and has satisfactory resistance to pitting corrosion, and a process for fabricating the tube.

### DISCLOSURE OF THE INVENTION

To fulfill the above object, the present invention comprises the following modes.

1) An aluminum heat exchange tube made of an alloy containing 0.90 to 1.50 mass % of Mn, the balance being Al and inevitable impurities, the tube having electric conductivity of 30 to 43% IACS.

With the aluminum heat exchange tube according to par. 1), Mn is effective for giving improved resistance to pitting corrosion and an improved strength, but if the content thereof is less than 0.90 mass %, this effect is not available. If the content is over 1.50 mass %, the effect to give an improved strength levels off, while hot working encounters increased resistance to deformation, and the material to be made into the aluminum heat exchange tube exhibits impaired workability, for example, impaired extrudability. Accordingly, the alloy for making the aluminum heat exchange tube should be 0.90 to 1.50 mass % in Mn content. The Mn content is preferably 1.0 to 1.2 mass %.

If the tube according to par. 1) is less than 30% IACS in electric conductivity, this indicates insufficient Mn content, which leads to a lower strength. When the conductivity is over 43% IACS, Mn and inevitable impurities fail to form satisfactory solid solutions in the matrix to result in lower corrosion resistance. Accordingly, the conductivity of the alloy for making the aluminum heat exchange tube should be 30 to 43% IACS and is preferably 33 to 37% IACS.

2) An aluminum heat exchange tube according to par. 1) wherein the inevitable impurities include Cu, and the content of Cu is up to 0.05 mass %.

With the aluminum heat exchange tube according to par. 2), the inevitable impurity Cu, even if present in a very small amount, is likely to impair the pitting corrosion resistance of the tube. Accordingly, the Cu content is up to 0.05 mass %.

3) An aluminum heat exchange tube according to par. 1) wherein the inevitable impurities include Fe, and the content of Fe is up to 0.25 mass %.

With the aluminum heat exchange tube according to par. 3), the inevitable impurity of Fe is likely to impair the pitting corrosion resistance of the tube although less influential than Cu. Accordingly, it is desirable that the Fe content be up to 0.25 mass %.

4) An aluminum heat exchange tube according to par. 1) wherein the inevitable impurities include Si, and the content of Si is up to 0.25 mass %.

With the aluminum heat exchange tube according to par. 4), the inevitable impurity of Si, like Fe, will lower the pitting corrosion resistance of the tube. It is therefore desirable that the Si content be up to 0.25 mass %.

5) A process for fabricating an aluminum heat exchange tube characterized in that a tube blank made of an alloy comprising 0.90 to 1.50 mass % of Mn, and the balance Al and inevitable impurities is held heated at 550 to 600° C. in the atmosphere or in an inert gas atmosphere for 10 to 600 minutes and subsequently cooled.

With the process according to par. 5) for fabricating an aluminum heat exchange tube, the tube blank is held heated at a predetermined temperature for a specified period of time, whereby the Mn and inevitable impurities in the alloy making the tube blank form solid solutions in the matrix, thereby reducing the amounts of crystals and precipitates serving as nuclei in the material for causing corrosion, giving improved corrosion resistance and consequently resulting in lower electric conductivity to impart improved pitting corrosion resistance to the aluminum heat exchange tube fabricated. The heating temperature used is 550 to 600° C. because if the temperature is lower than 550° C., Mn and inevitable impurities will not sufficiently form solid solutions in the matrix, and further because temperatures in excess of 600° C. are merely inefficient economically, failing to give an improved effect to form solid solutions of Mn and inevitable impurities in the matrix. The blank is held as heated for 10 to 600 minutes because if this period is less than 10 minutes, Mn and inevitable impurities will not sufficiently dissolve in the solid matrix, while periods exceeding 600 minutes lead only to a lower efficiency economically and fail to produce an improved effect to form solid solutions of Mn and inevitable impurities in the matrix.

6) A process for fabricating an aluminum heat exchange tube according to par. 5) wherein the alloy making the tube blank contains Cu as included among the inevitable impurities, and the content of Cu is up to 0.05 mass %.

7) A process for fabricating an aluminum heat exchange tube according to par. 5) wherein the alloy making the tube blank contains Fe as included among the inevitable impurities, and the content of Fe is up to 0.25 mass %.

8) A process for fabricating an aluminum heat exchange tube according to par. 5) wherein the alloy making the tube blank contains Si as included among the inevitable impurities, and the content of Si is up to 0.25 mass %.

9) A process for fabricating an aluminum heat exchange tube according to par. 5) wherein the temperature is raised at a rate of 20 to 130° C./min for heating the blank.

In the tube fabrication process according to par. 9), the temperature is raised at a rate of 20 to 130° C./min for heating because rates lower than 20° C./min are economically inefficient, whereas if the rate is in excess of 130° C./min, other aluminum products to be heated at the same time will vary in the rate of rise of temperature.

10) A process for fabricating an aluminum heat exchange tube according to par. 5) wherein the blank is cooled at a rate of at least 47° C./min after the heating.

In the tube fabrication process of par. 10), the cooling rate after the heating is at least 47° C./min because if the cooling rate is less than 47° C./min, the Mn and inevitable impurities forming solid solutions in the matrix will separate out again, possibly entailing impaired corrosion resistance.

11) A heat exchanger comprising an aluminum heat exchange tube according to any one of pars. 1) to 4).

12) A refrigeration cycle which comprises a compressor, a capacitor and an evaporator and wherein a chlorofluorocarbon refrigerant is used, the condenser being a heat exchanger according to par. 11).

13) A vehicle having installed therein a refrigeration cycle according to par. 12) as a motor vehicle air conditioner.

14) A supercritical refrigeration cycle which comprises a compressor, a gas cooler, an evaporator and an intermediate heat exchanger for subjecting a refrigerant flowing of the gas cooler and a refrigerant flowing out of the evaporator to heat exchange and wherein a supercritical refrigerant is used, the gas cooler comprising a heat exchanger according to par. 11).

15) A vehicle having installed therein a refrigeration cycle according to par. 14) as a motor vehicle air conditioner.

The aluminum heat exchange tube according to par. 1) has electric conductivity of 30 to 43% IACS and can therefore be prevented from developing pitting corrosion without necessitating the chromate treatment or zinc thermal spraying. Since the tube is made from an alloy comprising 0.90 to 1.50 mass % of Mn, and the balance Al and inevitable impurities, the tube having an improved strength can be fabricated with satisfactory workability. The tube can be fabricated merely by holding a blank heated at a predetermined temperature in the atmosphere or an inert gas atmosphere for a specified period of time, and subsequently cooling the blank, and is therefore easy and inexpensive to make.

The aluminum heat exchange tubes according to pars. 2) to 4) are further improved in pitting corrosion resistance.

The aluminum heat exchange tubes described can be fabricated relatively easily at a low cost by the process according to par. 5).

The tube fabrication processes according to pars. 6) to 8) provide aluminum heat exchange tubes described in pars. 2) to 4), respectively, relatively easily at a low cost.

The tube fabrication processes according to pars. 9) and 10) ensure a high efficiency economically to provide aluminum heat exchange tubes having reliable pitting corrosion resistance.

### BRIEF DESCRIPTION OF THE DRAWINGS

FIG. 1 is a perspective view showing a condenser comprising an aluminum heat exchange tube of the invention and useful for motor vehicle air conditioners wherein a chlorofluorocarbon refrigerant is used. FIG. 2 is a diagram showing a heating temperature pattern of Examples 1 to 4.

### BEST MODE OF CARRYING OUT THE INVENTION

An embodiment of the invention will be described below with reference to the drawings.

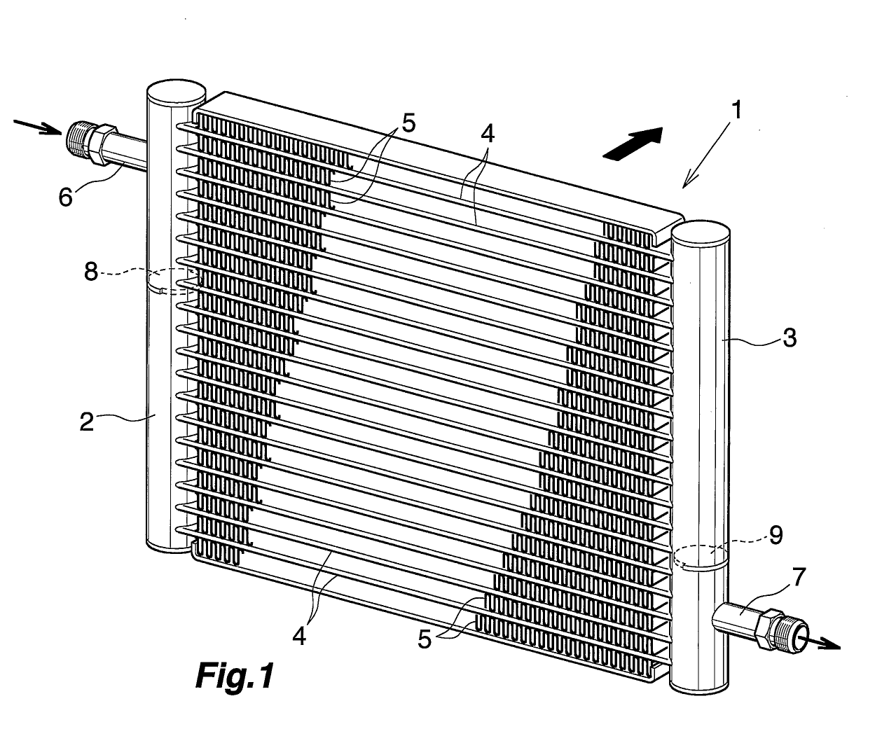

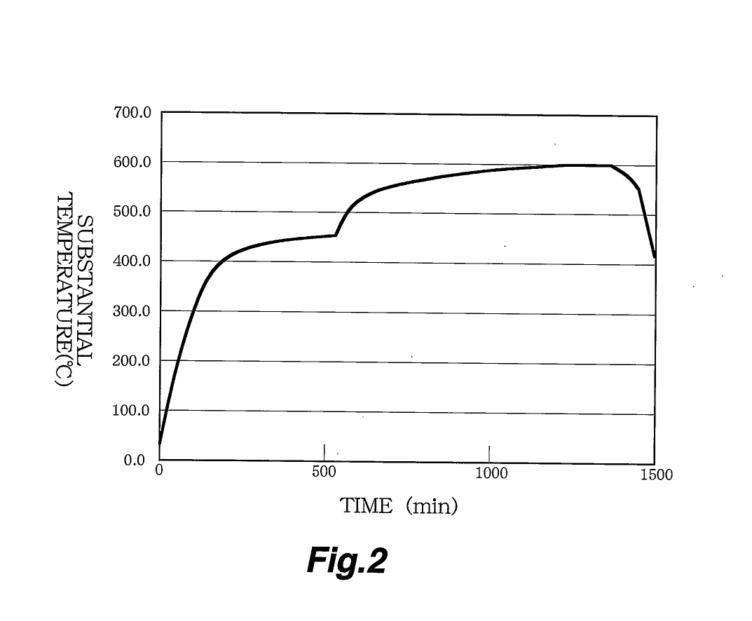

FIG. 1 shows a condenser adapted for use in motor vehicle air conditioners and comprising an aluminum heat exchange tube according to the invention.

With reference to FIG. 1, the condenser 1 for use in motor vehicle air conditioners wherein a chlorofluorocarbon refrigerant is used comprises a pair of aluminum first and second headers 2, 3 made of aluminum and arranged in parallel as spaced apart from each other, flat heat exchange tubes 4 each made of aluminum extrudate, arranged in parallel and each having opposite ends joined to the respective headers 2, 3, corrugated fins 5 made of aluminum brazing sheet, each disposed in an air passage clearance between each adjacent pair of heat exchange tubes 4 and brazed to the pair of heat exchange tubes 4, an inlet pipe 6 made of aluminum extrudate and welded to an upper end portion of peripheral wall of the first header 2, an outlet pipe 7 made of aluminum extrudate and welded to a lower end portion of peripheral wall of the second header 3, a first partition plate 8 provided inside the first header 2 above the midportion thereof and a second partition plate 9 provided inside the second header 3 below the midportion thereof.

The number of heat exchange tubes 4 arranged above the first partition plate 8, the number of heat exchange tubes 4 arranged between the first partition plate 8 and the second partition plate 9, and the number of heat exchange tubes arranged below the second partition plate 9 successively decrease from above downward to provide groups of channels. A refrigerant flowing in through the inlet pipe 6 in a vapor phase flows zigzag through the channel groups as units inside the condenser 1 before flowing out from the outlet pipe 7 in a liquid phase.

The heat exchange tubes 4 are made of an alloy containing 0.90 to 1.50 mass % of Mn, the balance being Al and inevitable impurities, and the tubes have electric conductivity of 30 to 43% IACS. Although not shown, each of the heat exchange tubes 4 has a plurality of refrigerant passageways arranged in parallel.

In the case where the alloy making the heat exchange tube 4 contains Cu as an inevitable impurity, the content of the inevitable impurity of Cu is preferably up to 0.05 mass %. When the alloy making the heat exchange tube 4 contains Fe as an inevitable impurity, the content of the inevitable impurity of Fe is preferably up to 0.25 mass %. Further when the alloy making the heat exchange tube 4 contains Si as an inevitable impurity, the content of the inevitable impurity of Si is preferably up to 0.25 mass %.

The heat exchange tube 4 is fabricated, for example, in the following manner.

The alloy described above is extruded into a tube blank. The tube blank is held heated at 550 to 600° C. in the atmosphere or in an inert gas atmosphere for 10 to 600 minutes and subsequently cooled. For heating the blank, the temperature is raised preferably at a rate of 20 to 130° C./min, and after the heating, the blank is cooled preferably at a rate of at least 47° C./min. In this way, the heat exchange tube 4 is fabricated.

When the tube blank is held heated at a predetermined temperature for a specified period of time, the Mn and inevitable impurities in the alloy making the blank form solid solutions in the matrix, thereby reducing the amounts of crystals and precipitates serving as nuclei in the material for causing corrosion, giving improved corrosion resistance and consequently resulting in lower electric conductivity to impart improved pitting corrosion resistance to the aluminum heat exchange tube fabricated.

In fabricating the condenser 1, heat exchange tubes 4 may be made simultaneously when headers 2, 3 are brazed to the heat exchange tubes 4 and when the tubes 4 are brazed to corrugated fins 5.

According to the present embodiment, the aluminum heat exchange tube of the invention is used in condensers for use in motor vehicle air conditioners which are refrigeration cycles wherein a chlorofluorocarbon refrigerant is used. The tube may alternatively be used in evaporators for use in motor vehicle air conditioners.

The heat exchange tube of the invention may be used also in motor vehicle air conditioners, i.e., in refrigeration cycles which comprise a compressor, gas cooler, evaporator and intermediate heat exchanger for subjecting the refrigerant flowing out of the gas cooler and the refrigerant flowing out of the evaporator to heat exchange, and wherein CO₂ or like supercritical refrigerant is used, to serve as the tube of the gas cooler or evaporator.

The present invention will be described below with reference to specific examples and comparative examples.

### EXAMPLES 1-4

Blanks for heat exchange tubes, 16 mm in width, 2 mm in height (thickness), 18 in the number of refrigerant passageways and 0.3 mm in the thickness of peripheral walls, were extruded from four kinds of alloys having respective compositions shown in Table 1.

TABLE 1

| | | | | | | | Maximum |
|---|---|---|---|---|---|---|---|
| | | | | | | Eelectric | corrosion |
| | Composition (mass %) | | | | | conductivity | depth |
| | Al | Mn | Cu | Fe | Si | (% IACS) | (μm) |
| Example 1 | Bal. | 1.12 | 0.01 | 0.12 | 0.03 | 33.8 | 233 |
| Example 2 | Bal. | 1.09 | 0.01 | 0.15 | 0.05 | 37.0 | 209 |
| Example 3 | Bal. | 0.90 | 0.01 | 0.22 | 0.07 | 36.8 | 306 |
| Example 4 | Bal. | 1.07 | 0.01 | 0.23 | 0.07 | 40.1 | 494 |

Subsequently, the tube blanks were placed into a preheating furnace set at an internal temperature of 500° C., held therein for 10 minutes, thereafter placed into a main heating furnace set at an internal temperature of 601° C. and held therein so as to be maintained substantially at a temperature of 600° C. for 3 minutes, whereupon the tube blanks were cooled substantially to a temperature of 570° C. with nitrogen gas. The tube blanks were thereafter withdrawn from the furnace. The temperature was raised at a rate of 30° C./min for heating, and the blanks were cooled at a rate of 60° C./min. FIG. 2 shows the heating temperature pattern.

The heat exchange tubes thus fabricated were checked for electric conductivity. Table 1 also shows the result.

The heat exchange tubes were subjected to SWAAT 960-hr test and checked for corrosion. Table 1 shows the maximum corrosion depths of the tubes. Table 2 shows the state of corrosion developing in the heat exchange tubes, i.e., the depth of corrosion and the number of corrosion faults.

TABLE 2

| | Example 1 | | Example 2 | | Example 3 | | Example 4 | |
|---|---|---|---|---|---|---|---|---|
| | Corrosion | | Corrosion | | Corrosion | | Corrosion | |
| | depth (μm) | Number | depth (μm) | Number | depth (μm) | Number | dept (μm) | Number |
| State of | Up to 100 | 3 | Up to 100 | 4 | Up to 100 | 3 | Up to 100 | 1 |
| resulting | 100-200 | 3 | 100-200 | 7 | 100-200 | 10 | 100-200 | 6 |
| corrosion | 200-300 | 1 | 200-300 | 0 | 200-300 | 2 | 200-300 | 4 |
| | 300-400 | 0 | 300-400 | 0 | 300-400 | 1 | 300-400 | 0 |
| | 400-500 | 0 | 400-500 | 0 | 400-500 | 0 | 400-500 | 1 |

### COMPARATIVE EXAMPLES 1-4

Blanks for heat exchange tubes, 16 mm in width, 2 mm in height (thickness), 18 in the number of refrigerant passageways and 0.3 mm in the thickness of peripheral walls, were extruded from four kinds of alloys having respective compositions shown in Table 1. The tube blanks were subjected to SWAAT 960-hr test without being heated for treatment and thereafter checked for the resulting corrosion. The blanks were found to have pits extending though the thickness of the peripheral wall.

### INDUSTRIAL APPLICABILITY

The aluminum heat exchange tube of the invention is suitable, for example, for use in heat exchangers such as condensers or evaporators in motor vehicle air conditioners wherein a chlorofluorocarbon refrigerant is used, and gas coolers or evaporators in motor vehicle air conditioners wherein CO₂ or like supercritical refrigerant is used.

1. An aluminum heat exchange tube made of an alloy containing 0.90 to 1.50 mass % of Mn, the balance being Al and impurities, the tube having electric conductivity of 30 to 43% IACS.

2. An aluminum heat exchange tube according to claim 1 wherein the impurities include Cu, and the content of Cu is up to 0.05 mass %.

3. An aluminum heat exchange tube according to claim 1 wherein the impurities include Fe, and the content of Fe is up to 0.25 mass %.

4. An aluminum heat exchange tube according to claim 1 wherein the impurities include Si, and the content of Si is up to 0.25 mass %.

5. A process for fabricating an aluminum heat exchange tube wherein a tube blank made of an alloy comprising 0.90 to 1.50 mass % of Mn, and the balance Al and impurities is held heated at 550 to 600° C. in the atmosphere or in an inert gas atmosphere for 10 to 600 minutes and subsequently cooled.

6. A process for fabricating an aluminum heat exchange tube according to claim 5 wherein the alloy making the tube blank contains Cu as included among the impurities, and the content of Cu is up to 0.05 mass %.

7. A process for fabricating an aluminum heat exchange tube according to claim 5 wherein the alloy making the tube blank contains Fe as included among the impurities, and the content of Fe is up to 0.25 mass %.

8. A process for fabricating an aluminum heat exchange tube according to claim 5 wherein the alloy making the tube blank contains Si as included among the impurities, and the content of Si is up to 0.25 mass %.

9. A process for fabricating an aluminum heat exchange tube according to claim 5 wherein the temperature is raised at a rate of 20 to 130° C./min for heating the blank.

10. A process for fabricating an aluminum heat exchange tube according to claim 5 wherein the blank is cooled at a rate of at least 47° C./min after the heating.

11. A heat exchanger comprising an aluminum heat exchange tube according to claim 1.

12. A refrigeration cycle which comprises a compressor, a capacitor and an evaporator and wherein a chlorofluorocarbon refrigerant is used, the condenser being a heat exchanger according to claim 11.

13. A vehicle having installed therein refrigeration cycle according to claim 12 as a motor vehicle air conditioner.

14. A supercritical refrigeration cycle which comprises a compressor, a gas cooler, an evaporator and an intermediate heat exchanger for subjecting a refrigerant flowing of the gas cooler and a refrigerant flowing out of the evaporator to heat exchange and wherein a supercritical refrigerant is used, the gas cooler comprising a heat exchanger according to claim 11.

15. A vehicle having installed therein a refrigeration cycle according to claim 14 as a motor vehicle air conditioner.
